(19) United States
(12) Patent Application Publication
(10) Pub. No.: US 2012/0255414 A1
(43) Pub. Date: Oct. 11, 2012

(54) Modular Laser Alignment Device for Power Tool

(75) Inventor: Jan Koegel, Arlington Heights, IL (US)

(73) Assignees: ROBERT BOSCH GMBH, Stuttgart (DE); ROBERT BOSCH TOOL CORPORATION, Broadview, IL (US)

(21) Appl. No.: 13/081,647

(22) Filed: Apr. 7, 2011

(51) Int. Cl. B23D 45/06; B23D 59/00

(52) U.S. Cl. 83/477.2; 83/520

(57) ABSTRACT

A table saw including a table top having an opening configured to receive a blade. A cutting tool is configured to rotate the blade within the opening of the table top. A light alignment apparatus is configured to be selectively mounted in an upright manner at a plurality of locations on the table saw and direct a beam of light on to the table top from each of the plurality of locations on the table saw. The plurality of locations on the table saw include a first location on the table top and a second location on the cutting tool.

### FIELD

This application relates to the field of power tools and particularly to alignment devices for power tools.

### BACKGROUND

Table saws and other power tools include blades configured to cut workpieces of various shapes and sizes. When using a table saw to produce a cut in a workpiece, the user typically moves the blade in a straight line into engagement with the workpiece or, alternatively, moves the workpiece in a straight line into engagement with the blade. The user attempts to maintain a proper alignment between the workpiece and the blade during the cutting action in order to produce the desired cut in the workpiece. Therefore, users of table saws need to visualize where a cut will occur on a workpiece both before and during the time the cut is being made.

In order to assist the user in making a cut at the desired location on a workpiece, some power tools include an alignment tool using a light, such as laser light. The light may serve to illuminate the work area and also provide a kerf indicator for the cutting tool.

Kerf indicators have been provided in different ways. The typical arrangement used to provide a kerf indicator involves mounting a laser light on the cutting tool. These laser lights are configured to shine a laser light toward the table top such that an illuminated line is provided on the table top in front of the saw. While these arrangements are generally satisfactory, they are limited by only providing the user with a single illuminated line on the table top. Moreover, the illuminated lines provided by the alignment tool are limited to lines that indicate where the saw blade will move, but are not as useful for providing the user with laser lines at various angles that may be used for marking on a workpiece. For example, kerf indicators do not provide lines at a perpendicular or other angle to the kerf.

In view of the foregoing, it would also be advantageous to provide an alignment device that is configured to provide an illuminated line of light at various locations on the table saw. It would also be advantageous if this alignment device could be manipulated by the user to shine light from various directions onto the table top. Additionally, it would be advantageous if the user could use two the alignment device to facilitate marking workpieces positioned on the table top.

### SUMMARY

In accordance with at least one embodiment of the disclosure, there is provided a table saw including a table top having an opening configured to receive a blade. A cutting tool is configured to rotate the blade within the opening of the table top. A light alignment apparatus is configured to be selectively mounted in an upright manner at a plurality of locations on the table saw and direct a beam of light on to the table top from each of the plurality of locations on the table saw. The plurality of locations on the table saw include a first location on the table top and a second location on the cutting tool.

Pursuant to another embodiment of the disclosure there is provided a table saw comprising a table top including a work surface with a plurality of edges. The work surface includes an opening configured to receive a blade. A cutting tool is configured to rotate the blade within the opening of the work surface. A light alignment apparatus configured to be selectively secured to a plurality of locations on the plurality of edges of the table saw.

Pursuant to yet another embodiment of the disclosure there is provided a light alignment apparatus for a power tool. The light alignment apparatus comprises a frame with a laser housing, the frame configured to be releasably connected to the power tool. A laser is positioned within the laser housing. A support is configured to hold the frame when the frame is not connected to the power tool. The support is further configured to position the frame and laser in an upright manner on a table top such that the laser directs an illuminated line of light on to the table top.

The above described features and advantages, as well as others, will become more readily apparent to those of ordinary skill in the art by reference to the following detailed description and accompanying drawings. While it would be desirable to provide an alignment device for a power tool that provides one or more of the foregoing or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

FIG. 1 shows a perspective view of a table saw with a laser alignment device positioned on a cutting tool;

FIG. 2 shows a side perspective view of the laser alignment device of FIG. 1;

FIG. 3 shows a top perspective view of the laser alignment device of FIG. 2 with the laser housing pivoted;

FIG. 4 shows a cutaway side view of the laser alignment device of FIG. 2;

FIG. 5A shows a cutaway side view of an adjustment mechanism within the laser housing of the laser alignment device of FIG. 2 with the laser diode in a first position;

FIG. 5B shows a cutaway side view of the adjustment mechanism of FIG. 5A with the laser diode in a second position;

FIG. 6 shows an illustration of the movement of the laser diode with the adjustment mechanism of FIGS. 5A and 5B;

FIG. 7 shows a perspective view of another embodiment of the table saw with the laser alignment device of FIG. 1 with the laser alignment device positioned on the cutting tool;

FIG. 8 shows an alternative embodiment of the table saw with the laser alignment device of FIG. 1 with the laser alignment device mounted on a side track on a perimeter of the table top;

FIG. 9 shows a perspective view of a mount member configured to mount the laser alignment device of FIG. 8 to the side track;

FIG. 10 shows a side view of the mount member of FIG. 9 engaging the side track;

FIG. 11 an alternative embodiment of the table saw with the laser alignment device of FIG. 8 positioned on the upper surface of the table top;

FIG. 12 shows a top view of an alternative embodiment of the laser alignment device of FIG. 8 with the laser alignment device including an adjustment arc;

FIG. 13 shows an perspective view of the laser alignment device of FIG. 12;

FIG. 14 shows a perspective view of another alternative embodiment of the laser alignment device of FIG. 8 in association with a table saw; and

FIG. 15 shows a perspective view of yet another alternative embodiment of the laser alignment device of FIG. 8 in association with a table saw.

### DESCRIPTION

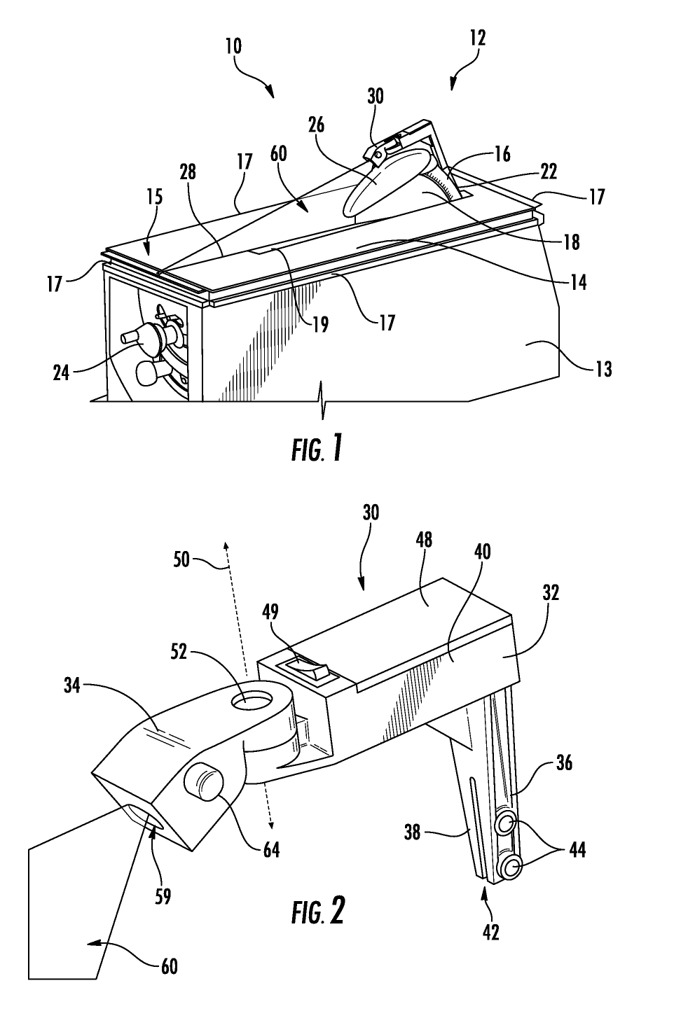

With general reference to FIG. 1, an embodiment of a power tool 10 with a light alignment apparatus 30 is shown. The power tool 10 is a table saw 12 that includes a table top 14 and a cutting tool 16. The cutting tool 16 is a saw configured to rotate a saw blade 18. The light alignment apparatus 30 is mounted on the table saw 12 and is configured to direct a beam of light on to the table top 14. As explained in further detail below, the light alignment apparatus 30 is configured to be selectively mounted on the cutting tool 16 and on one or more additional locations on the table saw 12. In particular, the light alignment apparatus 30 is configured to be mounted to one or more locations on the table top 14.

Table Saw Arrangement

The table saw 12 used in association with the light alignment device may be any of various different types of table saws that include a cutting tool 16 supported by a table having a base 13 and a table top 14. The cutting tool 16 is generally a saw or other rotating machine powered by an electric motor (not shown) and configured to rotate a blade 18. Examples of such table saws include the push-pull type table saw 12 of FIG. 1, as well as other table saws such as router tables with rotating router bits or table saws with circular saw blades that rotate but do not move in an axial direction. Accordingly, it will be recognized that the various embodiments of the light alignment apparatus 30 disclosed herein may be used in association with various types of table saws or other power tools.

The table top 14 of the table saw 12 is supported by the table base 13. The table top includes a flat upper surface 15 with a plurality of edges 17 that define a rectangular perimeter for the table top 14. While a rectangular perimeter is disclosed in the embodiment of FIG. 1, it will be recognized that the table top 14 may also be provided in various shapes and sizes. The upper surface 15 of the table top is generally flat and smooth such that a board or other workpiece (not shown) may be laid flat on the table top 14.

The table base 13 generally provides a frame structure that holds the table top 14 in an elevated position above the table base 13. The table base 13 may be provided in any of a number of different forms. In the embodiment of FIG. 1, the table base 13 is provided as a housing structure, including four walls. Various table saw controls 24 such as a power switch, pull rod, or bevel adjustment member may be provided on the front wall of the housing. While a table base 13 with walls has been shown in the embodiment of FIG. 1, in other embodiments the table base 13 may be differently configured, such as a frame of metallic support members without walls secured thereto.

The push-pull table saw 12 of FIG. 1 includes a moveable carriage (not shown) that is coupled to the underside of the table top 14. The carriage holds the cutting tool 16 with the circular saw blade 18 extending through an opening formed in the table top 14. The opening in the table top 14 is generally provided in the form of an elongated slot 19, allowing the saw blade 18 to move in a linear direction along the table top 14. A riving knife 22 is positioned on the rear side of the saw and aligned with the circular saw blade 18. The riving knife 22 moves in the linear direction along with the circular saw blade 18. When electrical power is delivered to the cutting tool 16, the circular saw blade 18 rotates, allowing a user to cut a workpiece (not shown) positioned on the table top 14. A fence or several fences (not shown in FIG. 1) or other accessory attached to the table may assist the user in holding the workpiece 16 in place.

As shown in FIG. 1, a blade guard 26 covers an upper portion of the circular saw blade 18. The blade guard 26 is connected to the riving knife 22 and is moveable relative to the riving knife 22, e.g., at a pivot point or slot on the rear side of the saw. The blade guard 26 generally covers the top portion of the saw blade 18 without interfering with rotation of the saw blade 18. The blade guard 26 is positioned above the table top 14 by a clearance distance that allows the blade 14 to cut into a workpiece on the table top 14 as the blade guard passes over the workpiece.

The cutting tool 16 also includes a mount that is configured to hold the light alignment apparatus 30. As shown in the embodiment of FIG. 1, the riving knife 22 of the cutting tool 16 serves as the mount and is configured to hold the light alignment apparatus 30. Accordingly, the riving knife 22 may include mounting holes or other features that facilitate coupling of the light alignment apparatus 30 to the riving knife 22.

Light Alignment Apparatus

With reference now to the embodiment of FIGS. 2-4, the light alignment apparatus 30 includes a frame 32 with a laser housing 34 pivotably attached to the frame 32. The frame 32 is comprised of a rigid material, such as a metal or a hard plastic, in order to provide a stable support for the light alignment apparatus 30. As shown in FIGS. 2-4, the frame 32 may be L-shaped with two legs 36, 38 that extend downward from a battery compartment 40. The two legs 36, 38 are separated by a central slot 42 that is configured to receive the riving knife 22 such that the two legs 36, 38 straddle the riving knife 22. Mounting holes 44 are provided on the two legs. The mounting holes 44 are configured to receive a fastener (not shown), such as bolt, that extends through the mounting holes 44 on the frame 32 and also through the mounting holes on the riving knife 22, thus allowing the frame 22 to be coupled to the riving knife 22.

The battery compartment 40 is integral with the legs 36, 38 and includes a cavity 46 configured to receive at least one battery and a cover 48 that provides access to the battery cavity 46. Wires or other electrical conductors extend from the battery cavity 46 to the laser housing 34 in order to provide electrical power from a battery within the battery cavity 46 to a laser generator 54 within the laser housing 34. The electrical conductors are tied in to a switch 49 on the outer surface of the frame 32. The switch 49 may be moved between an “on” position where the battery is connected to the laser generator in the laser housing 34 and an “off” position where the battery is not connected to the laser generator in the laser housing 34.

The laser housing 34 is pivotably coupled to the frame 32 about a pivot axis 50. A pivot screw 52 extends through a hole in the laser housing 34 and another hole in the frame 32. The pivot screw 52 couples the laser housing 34 to the frame 32, while also defining the pivot axis 50. The laser housing 32 includes a front window 59 through which a beam of light 60 generated inside the laser housing 32 may shine. As shown in FIG. 3, the laser housing 34 is configured to pivot about 180° relative to the frame 32 (i.e., about 90° in either direction relative to a straight direction). Complimentary teeth may be provided on the laser housing 34 and the frame 32 to allow the laser housing 34 to be locked into various positions relative to the frame 32. The pivot screw 52 may be tightened by the user to lock the laser housing 34 in place or loosened to allow pivoting of the laser housing 34.

The laser housing 34 is comprised of a relatively rigid material such as a hard plastic or metal material that provides protection for the light generating apparatus positioned inside of the laser housing 34. Accordingly, the laser housing 34 substantially covers the light generating apparatus within the laser housing, providing only the window 59 through which the beam of light 60 can pass.

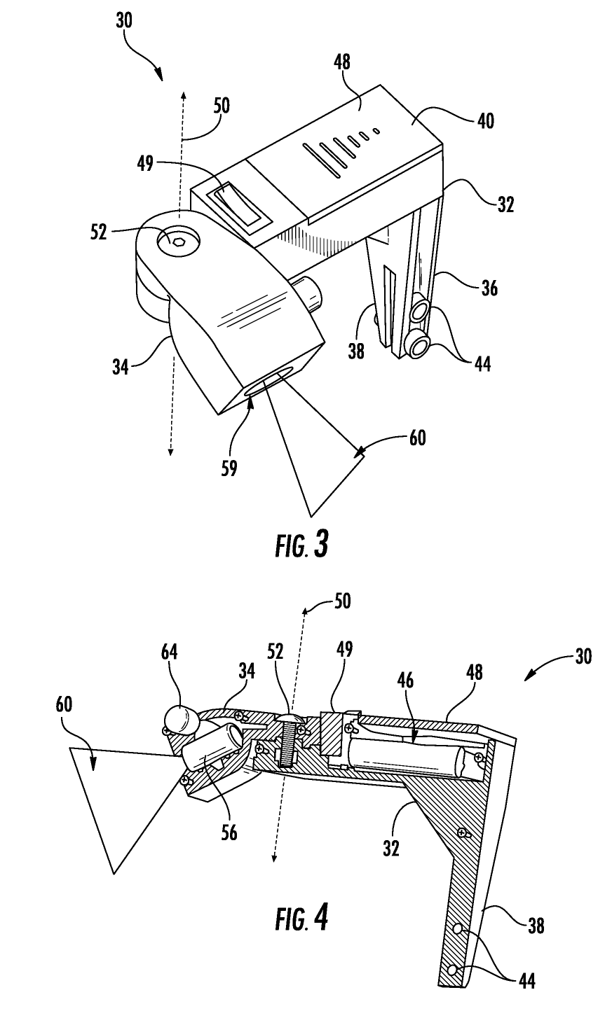

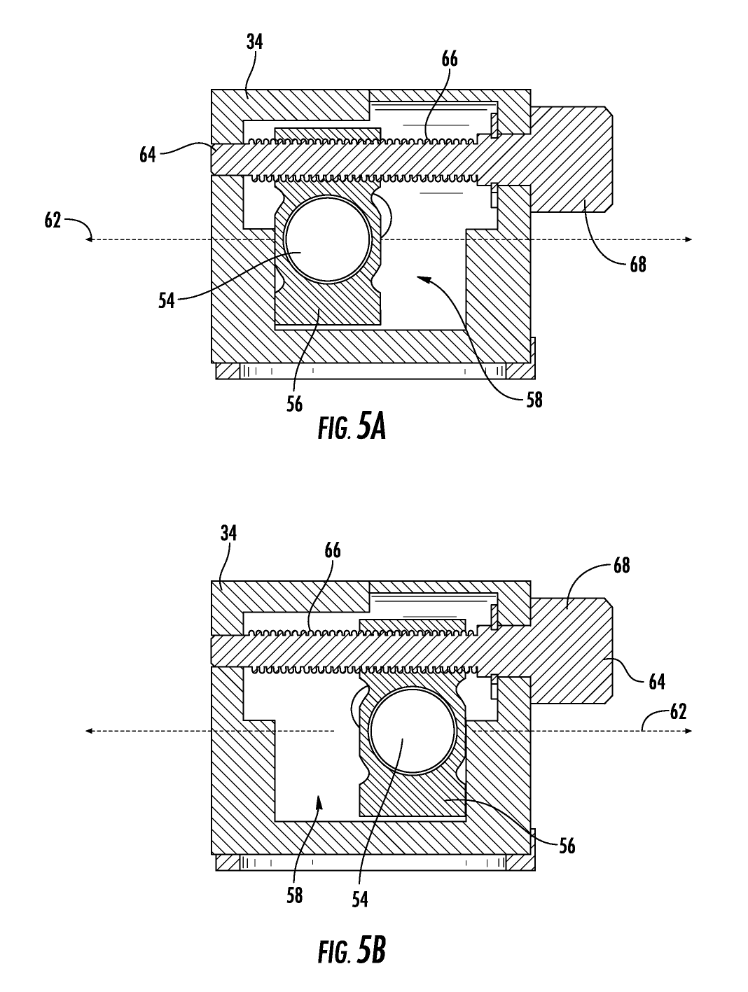

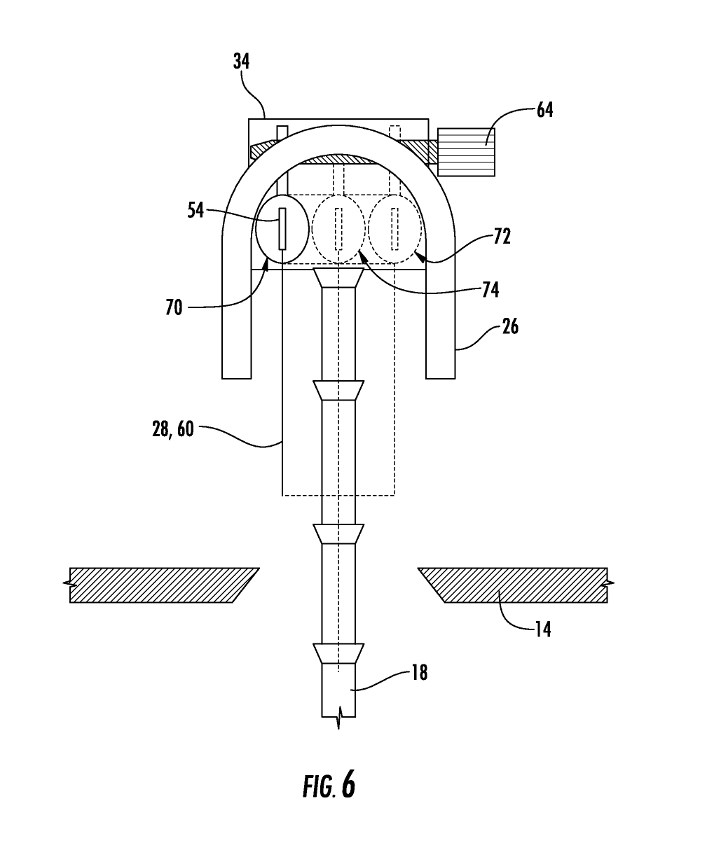

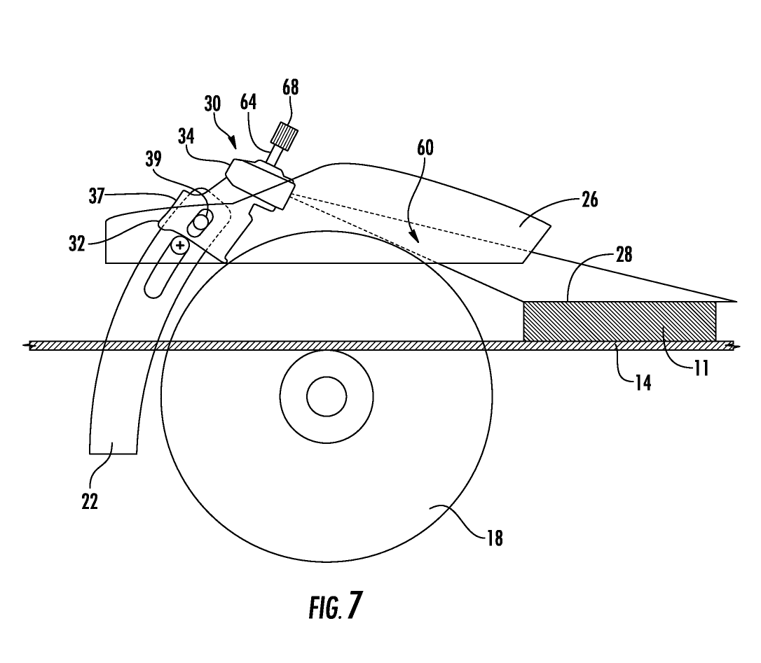

With reference now to FIGS. 4-5B, a laser generator 54 is positioned within a cavity 58 in the laser housing 34. The laser generator 54 is configured to generate a beam of light 60 that is directed through the window 59 in the laser housing 34. With reference again to FIG. 1, the laser generator 54 is positioned within the laser housing 34 such that the beam of light shines an illuminated line of light 28 on the table top 14.

With reference now to FIGS. 4, 5A and 5B, the laser generator 54 is provided by a laser diode positioned within a diode housing 56. The diode housing 56 is positioned within the cavity 58 such the diode housing 56 and associated laser diode 54 can only move in a lateral direction within the cavity 58, as indicated by arrow 62 in FIGS. 5A and 5B. An adjusting screw 64 extends through the laser housing 34 and the diode housing 56 in the lateral direction 62. Threads 66 on the shaft of the adjusting screw 64 engage complimentary threads on the diode housing 56. A knob 68 is connected to the end of the adjusting screw 64 and is positioned on the exterior of the laser housing 34. When the knob 68 is rotated by a user, the threads 66 engage the threads on the diode housing 56, resulting in lateral movement of the diode housing 56 within the cavity 58. FIG. 5A shows the diode housing positioned at a leftmost position within the laser housing 34. Sufficient rotation of the knob 68 will result in the diode housing moving to the rightmost position within the laser housing 34, as shown in FIG. 5B. While the laser generator has been disclosed as a laser diode 54 herein, in other embodiments different types of laser generators other than laser diodes may be utilized.

Light Alignment Apparatus on Cutting Tool

When the light alignment apparatus 30 is mounted to the cutting tool, such as the riving knife 22 as shown in FIG. 1, the light alignment apparatus 30 may be used to shine a beam of light 60 that provides an illuminated line of light 28 on the table top 14. The adjustable features on the light alignment apparatus 30 provide various degrees of freedom, allowing the user to direct the illuminated line of light 28 at different angles and at different positions along the table top 14. First, in a straight forward position, as shown in FIG. 1, the light alignment apparatus 30 is configured to shine the light beam 60 such that illuminated line of light 28 extends on the table top 14 in a direction that is parallel to the slot 19 in the table top 14 that receives the saw blade 18. Second, in a pivoted position, as shown in FIG. 3, the light alignment apparatus 30 is configured to shine the light beam 60 on the table top 14 such that the illuminated line of light 28 extends in a direction that is not parallel with the slot 19 that receives the saw blade 18. Third, as shown in FIGS. 5A and 5B, a fine adjustment mechanism is provided on the laser housing 34 with the adjusting screw 64, allowing the user to make small left or right adjustments in the position of the illuminated line of light 28 on the table top 14.

FIG. 6 is a front view illustration of various positions for the laser diode 54 relative to the saw blade 18 using the fine adjustment mechanism when the light alignment apparatus 30 is mounted on the riving knife 22. As mentioned above, rotation of the knob 68 results in movement of the laser diode 54 from the leftmost position 70 (shown in solid lines) and the rightmost position 72 (shown in dotted lines), and various positions in-between 74. Accordingly, when the laser housing 34 is in the straight forward position, the user is provided with a degree of freedom with the choice of shining the illuminated line of light on the left side of the saw blade or the right side of the saw blade. This may be useful to the user depending on whether the user is right-handed or left-handed, and the side of the saw blade 18 the user prefers to stand on. Moreover, the fine adjustment mechanism allows the user to move the illuminated line of light 28 between various positions on the left or right sides of the saw blade 18 depending on the thickness of the saw blade 18. In particular, for thicker saw blades, the user may adjust the laser diode 54 to the leftmost position 70 or the rightmost position 72. For thinner saw blades, the user may adjust the laser diode 54 to positions slightly closer to the center from the leftmost position 70 or the rightmost position 72.

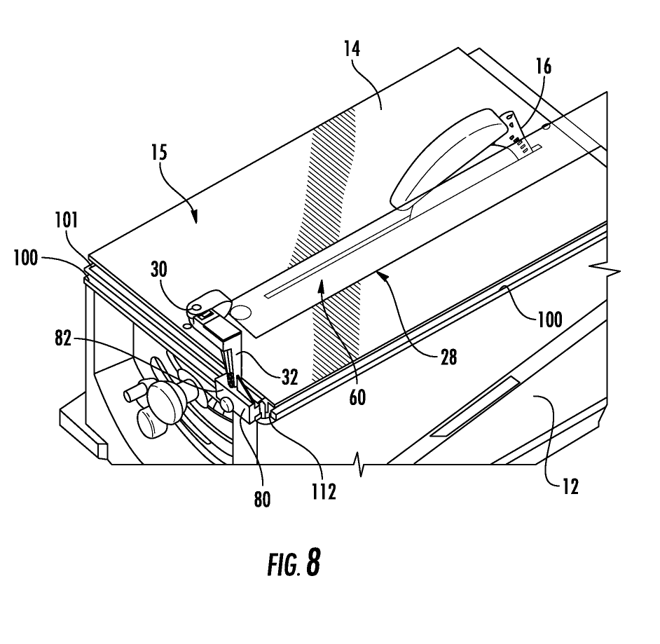

With reference now to FIG. 7, an alternative embodiment of the light alignment apparatus mounted to a riving knife 22 is shown. In this embodiment, light alignment apparatus 30 includes similar components to the embodiment of FIGS. 2-5, but instead of legs the frame 32 includes a bottom cuff 37 with an elongated slot 39 that receives a fastener, such as a bolt. The cuff 37 may be adjusted upward or downward on the riving knife 22 by loosening the fastener and allowing it to slide along the slot 39. The adjusting screw 64 for the laser generator 54 is also positioned above the laser housing 34 instead of to the side of the laser housing in this embodiment. FIG. 7 shows the illuminated line of light 28 provided from the beam of light 60 striking a workpiece 11 (e.g., a piece of wood) positioned on the table top 14. Similar to the embodiment of FIGS. 2-5, manipulation of the adjustment screw 64 allows the laser generator 54 to slide within the laser housing 34 and move the light beam 60 in a lateral direction from the left side to the right side of the blade 18, and vice-versa.

Light Alignment Apparatus on Table Top.

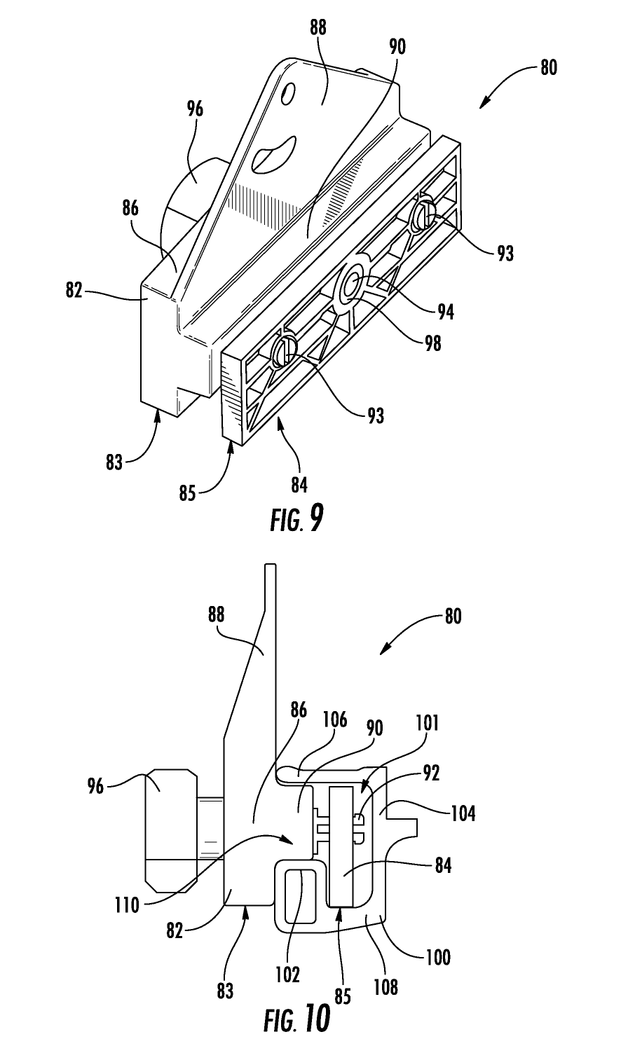

With reference now to FIG. 8, the light alignment apparatus 30 of the embodiment of FIGS. 1-5 is configured to be removed from the cutting tool 16 (as shown in FIG. 1) and coupled to the table top 14. In particular, the frame 32 of the light alignment apparatus 30 is configured to be coupled to a support member 80, and the support member 80 is configured to be coupled to the edge or other perimeter portion of the table top 14. As explained below, the support member 80 is configured to be positioned at various locations on the table top 14, allowing the light alignment apparatus 30 to direct a beam of light at various angles and locations on the upper surface 15 of the table top 14.

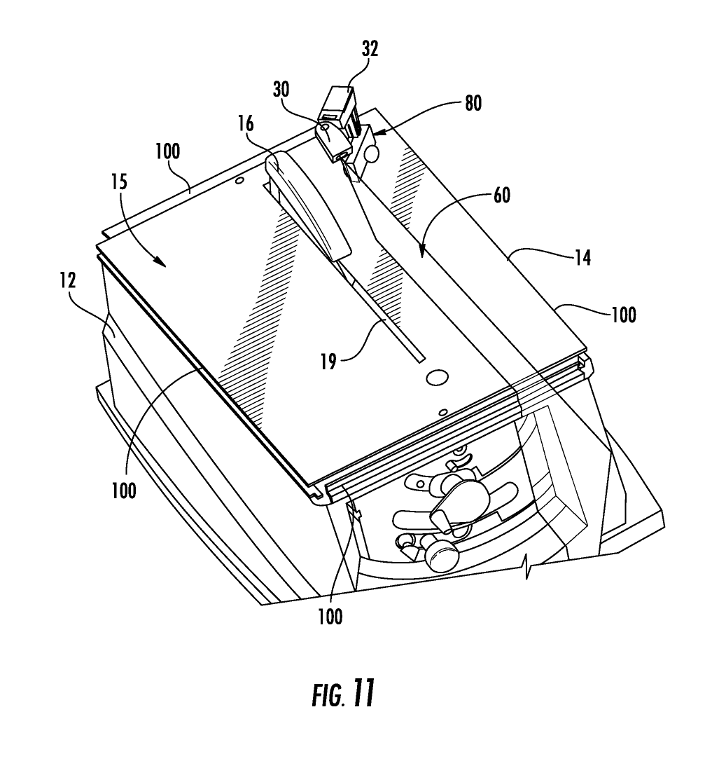

With reference now to FIGS. 9 and 10, the support member 80 includes a tower plate 82 that is coupled to a clamping plate 84. The tower plate 82 includes a rectangular main body portion 86 with an integral gable 88 extending upward from the main body portion 86, and an integral wedge member 90 extending rearward from the main body portion 86. The gable 88 has a thickness such that the two legs 36 and 38 of the light alignment apparatus 30 can straddle the gable. The gable 88 also includes two mounting holes 92 that align with the mounting holes 44 on the legs 36, 38. These holes 44 and 92 receive fasteners (such as bolts) that allow the frame 32 of the light alignment apparatus 30 to be securely coupled to the tower plate 82. The tower plate 82 is generally formed of a relatively strong and rigid material, such as steel, aluminum, or a hard plastic that is capable of supporting the light alignment apparatus 30 and holding it securely in place on the table top 14.

With continued reference to FIGS. 9 and 10, the clamping plate 84 of the support member is coupled to the tower plate 82 with two posts 92 that extend outward from the wedge member 90 of the tower plate 82. Each post 92 extends through a hole in the clamping plate 84 and includes an enlarged end 93 that prevent the post from releasing from the associated hole in the clamping plate 84. The posts 92 are longer than the width of the clamping plate 84, and thus the clamping plate 84 is capable of moving on the posts between the wedge 90 of the tower plate 82 and the enlarged ends 93 of the posts 92.

A bolt 94 extends through a hole in the tower plate 82 and another hole in the clamping plate 84. An enlarged knob 96 is connected to end of the bolt 94 on a front face of the tower plate 82. The opposite end of the bolt 94 engages a nut 98 that is retained within a hole in the clamping plate 84. When the knob 96 is rotated, threads on the bolt 94 engage complimentary threads on the nut 98 and draw the clamping plate 84 closer to the wedge 90 or force the clamping plate 84 further from the wedge member 90, depending on the direction of rotation of the bolt 94.

With particular reference now to FIGS. 8 and 10, a track 100 is provided along each edge of the table top 14. Each track 100 includes an internal groove 101 defined by a lower rail 102, a rear wall 104, an upper wall 106, and a lower wall 108. A forward channel 110 is also provided between the lower rail 102 and the upper wall 106. The clamping plate 84 is designed and dimensioned to fit within the internal groove 101 of the track 100, and the wedge member 90 of the tower plate 82 is configured to fit within the forward channel 110 of the track.

When a user rotates the knob 96 to draw the clamping plate 84 toward the wedge member 90, the clamping plate 84 is forced against the internal side of the lower rail 102 and the tower plate 82 is forced against the outer side of the lower rail 102, thus trapping the lower rail 102 between the tower plate 82 and the clamping plate 84, and locking the support member 80 in place in the track 100 on the edge of the table top 14. When the user rotates the knob 96 in the opposite direction, the clamping plate 84 is released from the lower rail 102, and is free to slide within the groove 101 of the track 100, allowing the support member 80 to be moved to a different position along the edge of the table top 14. Because the ends 112 of the tracks 100 are open, the support member 80 may be slid completely out of the track 100 on one edge of the table top 14 and positioned in a different track on another edge of the table top 14.

As explained above, because the support member 80 may be positioned at any of various locations on the table top 14, the light alignment apparatus 30 coupled to the support member 80 may also be positioned at any of various locations along the edge of the table top 14. This allows the light alignment apparatus 30 to direct an illuminated line of light on to the surface 15 of the table top 14 from any of various locations along the perimeter of the table top. Moreover, because the laser housing 34 of the light alignment apparatus 30 is pivotable with respect to the frame 32 (which is coupled to the support member 80), the laser alignment apparatus 30 is configured to shine the illuminated line of light 28 at various angles relative to the blade 18 from any of various perimeter positions on the table top 14. The various angles for the illuminated line of light 28 include angles that are parallel to the slot 19 and the blade 18 as well as other angles that are not parallel with the slot 19 and the blade 18.

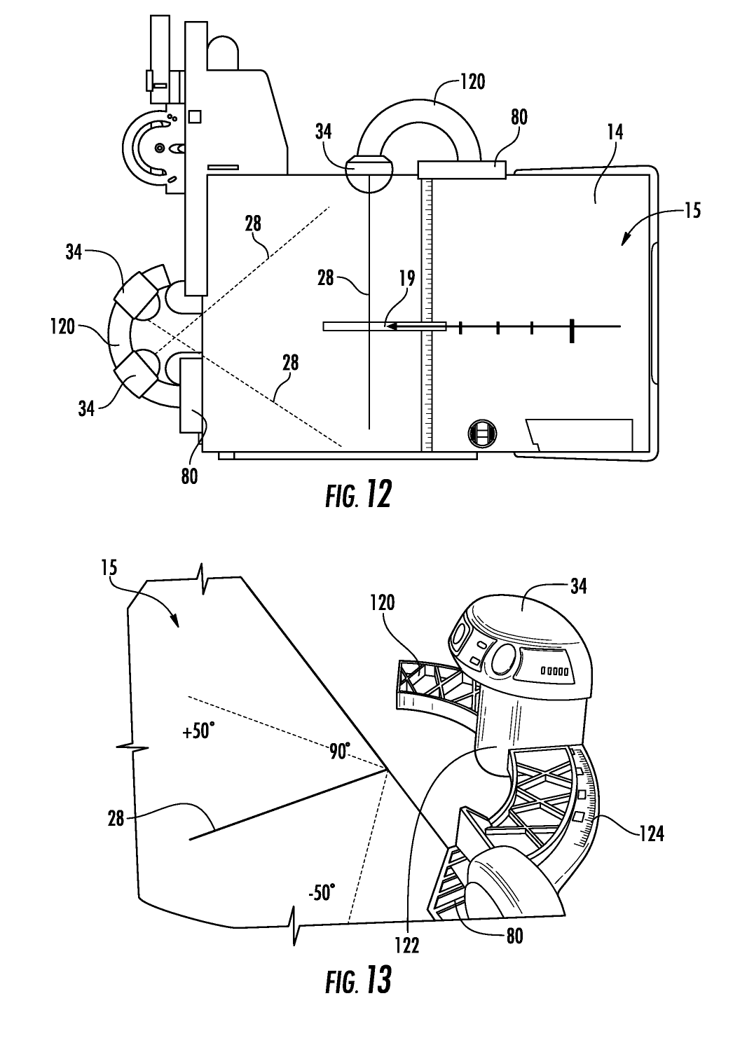

In addition to the ability to couple the light alignment apparatus 30 to the edges of the table top 14 as described above, the support member 80 is further configured to retain the light alignment apparatus in an upright position on the upper surface 15 of the table top 14. In particular, as shown in FIGS. 9 and 10, when the clamping plate 84 of the support member 80 is coupled to the tower plate 82, a flat lower surface 83 of the tower plate 82 is positioned in substantially the same plane as a flat lower surface 85 of the clamping plate 84. This provides two flat elongated feet 83 and 85 configured to rest on the flat upper surface 15 of the table top 14. When the frame 32 of the light alignment apparatus 30 is coupled to the support member 80, the elongated feet 83 and 85 act to hold the entire light alignment apparatus 30 in an upright position on the upper surface 15 of the table top 14, as shown in FIG. 11. When the light alignment apparatus 30 in held in the upright position, it is capable of directing the beam of light 60 on to the upper surface 15 of the table top 14 such that an illuminated line of light 28 is provided on the upper surface 15 of the table top 14. Therefore, the support member 80 is configured to engage the table top 14 in various manners while holding the light alignment apparatus 30 in an upright position. In particular, the support member is configured to (i) engage the edges of the table top 14 and hold the light alignment apparatus in an upright position and (ii) engage the upper surface 15 of the table top 14 and al hold the light alignment apparatus in an upright position.

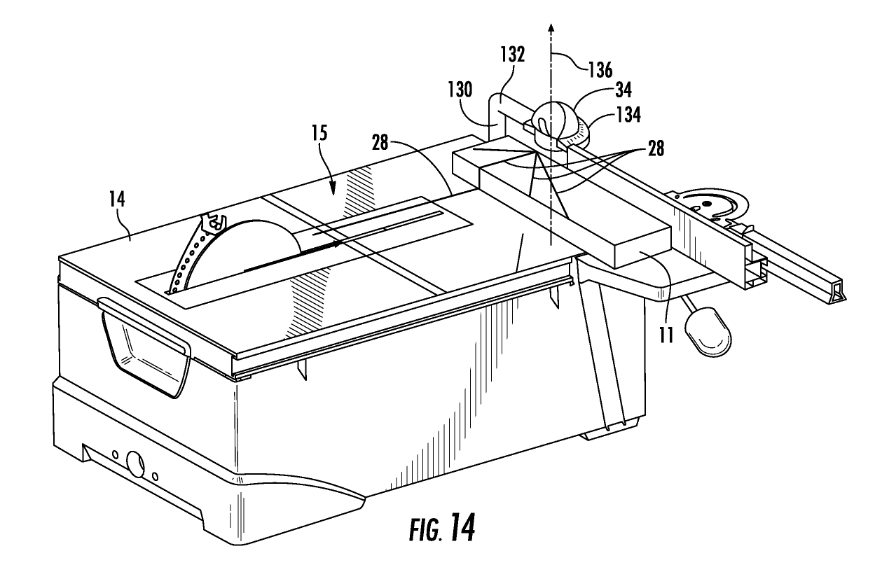

With reference now to FIGS. 12 and 13, in yet another embodiment of the light alignment apparatus 30, the frame 32 includes an arc-shaped portion 120 that is coupled to the support member 80. The laser housing 34 retains is configured differently than that described previously, and includes a lower carriage 122 that slideably engages the arc-shaped portion 120. For example, the lower carriage 122 may be provided by a sleeve member that encircles the arc-shaped portion 120, and slides along the arc-shaped portion 120. The arc-shaped portion may include indicia 124 on an upper surface that indicates the direction in which the beam of light 60 will be emitted relative to the saw blade 18. Thus, the indicia 124 may be numerical indications of degree. As shown in FIG. 12, a plurality of light alignment apparatus 30 may be provided on a plurality of support members 80. Accordingly, a plurality of illuminated lines of light 28 may be provided on the surface 15 of the table top 14. As shown in FIG. 13, the user slides the laser housing 34 on each arc-shaped portion 120 to a position that will provide the desired angle for the beam of light.

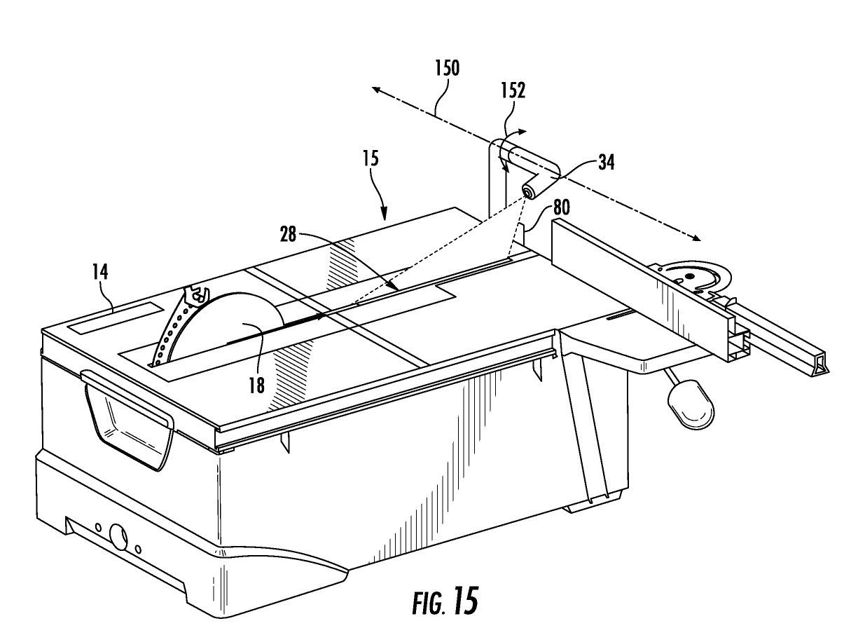

With reference now to FIG. 14, in at least one alternative embodiment, the frame 32 of the light alignment apparatus 30 includes a tower arm 130 that extends upward from the support member 80 and the table top 14. The tower arm 130 includes an elbow 132 that bends the arm 130 ninety degrees. The arm ends at a C-shaped support 134 that includes indicia on an upper surface to indicate the direction in which the beam of light 60 will be emitted relative to the saw blade 18. The laser housing 34 in the embodiment of FIG. 14 is configured differently than that described above. In particular, the laser housing 34 is substantially spherical, and is configured to rest in the C-shaped support 134. The laser housing 34 is also configured to pivot within the C-shaped support about a pivot axis 136. By moving the laser housing 34 about the pivot axis 136, the user is able to adjust the beam of illuminated line of light 28 provided by the laser generator to various desired angles relative to the blade 18 and slot 19 on the table top 14.

With reference now to FIG. 15, in yet another alternative embodiment the frame 32 of the light alignment apparatus 30 includes a tower arm 140 similar to that of FIG. 14. However, in the embodiment of FIG. 15, the horizontal portion of the tower arm 140 and the associated laser housing 34 is rotatable about axis 150 (as noted by arrow 152). This allows the laser line 28 to be extended differing lengths on the table. For example, when the laser housing 34 is in a downward position, the laser line 28 is brighter on the table top 15, but only extends a short distance (e.g., ¼ of the length of the table). When the laser housing 34 is in a more vertical position than directly downward, the laser line 28 is less bright, but extends longer on the table top (e.g., all the way to the blade 18 from the edge of the table top 14). In this embodiment of FIG. 15, the laser housing 34 also includes a left-to-right fine adjustment mechanism, similar to that described above in FIGS. 5 and 6, allowing the position of the laser line 28 on the upper surface 15 to be fine tuned.

The foregoing detailed description of one or more embodiments of the light guide alignment device has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

What is claimed is:

1. A table saw comprising:
a table top including an opening configured to receive a blade;
a cutting tool configured to rotate the blade within the opening of the table top; and
a light alignment apparatus configured to be selectively mounted in an upright manner at a plurality of locations on the table saw, wherein the light alignment apparatus is configured to direct a beam of light on to the table top from each of the plurality of locations, the plurality of locations including a first location on the table top and a second location on the cutting tool.

2. The table saw of claim 1 wherein the first location is a perimeter portion of the table top.

3. The table saw of claim 1 wherein the perimeter portion includes a first side perimeter and a second side perimeter, wherein the light alignment apparatus is configured to be selectively coupled to the first side perimeter and the second side perimeter.

4. The table saw of claim 2 wherein the plurality of locations further include a third location on an upper surface of the table top.

5. The table saw of claim 2 wherein the perimeter portion includes a first coupling arrangement extending along the perimeter portion, and wherein the light alignment apparatus is configured for connection to a second coupling arrangement that is complimentary to the first coupling arrangement may be removably connected to the second coupling arrangement, and the second coupling arrangement may be removably connected to the first coupling arrangement.

6. The table saw of claim 5 wherein the first coupling arrangement includes a track with a groove positioned along an edge of the table top, and wherein the second coupling arrangement includes a carrier configured to fit within the groove.

7. The table saw of claim 5 wherein the second coupling arrangement is configured to rest on an upper surface of the table top while holding the light alignment apparatus in the upright manner such that the light alignment apparatus can direct the beam of light on to the table top.

8. The table saw of claim 1 wherein the second location is a riving knife of the cutting tool.

9. The table saw of claim 1 wherein the light alignment apparatus comprises a laser generator.

10. The table saw of claim 1 wherein the light alignment apparatus is configured to direct a beam of light on to table top such that an illuminated line of light is provided on the table top.

11. A table saw comprising:
a table top including a work surface with a plurality of edges, the work surface including an opening configured to receive a blade;
a cutting tool configured to rotate the blade within the opening of the work surface; and
a light alignment apparatus configured to be selectively secured to a plurality of locations on the plurality of edges of the table saw.

12. The table saw of claim 11 wherein the light alignment apparatus is further configured to be selectively secured to the cutting tool.

13. The table saw of claim 12 wherein the wherein the light alignment apparatus includes a frame with a laser housing positioned on the frame and a laser diode positioned within the laser housing, wherein the frame is configured to be mounted to the riving knife of the cutting tool, wherein the laser diode is adjustable within the laser housing when mounted to the riving knife by movement of an adjustment member, the adjustment member configured to move the laser diode within the laser housing between a first position where the laser directs a beam of light along one side of the blade and a second position where the laser directs a beam of light along a opposite side of the blade.

14. The table saw of claim 11 wherein the light alignment apparatus is fastened to a support member when the light alignment apparatus is secured to one of the plurality of edges of the table saw, wherein the support member is further configured to rest on the work surface and hold the light alignment apparatus in an upright position.

15. The table saw of claim 11 wherein the light alignment apparatus includes a frame with a laser housing moveably positioned on the frame, and a laser generator positioned within the laser housing.

16. The table saw of claim 15 wherein the laser housing is configured to pivot on the frame.

17. The table saw of claim 15 wherein the frame includes an arc-shaped portion and the laser housing is configured to be secured at a plurality of positions along the arc-shaped portion.

18. The table saw of claim 17 wherein the laser generator is configured to provide an illuminated line of light on to the work surface that is not parallel with the blade or the opening in the table top.

19. The table saw of claim 15 wherein the laser generator is a laser diode that is moveably positioned within the laser housing.

20. A light alignment apparatus for a power tool comprising:
a frame with a laser housing, the frame configured to be releasably connected to the power tool;
a laser generator positioned within the laser housing;
a support configured to hold the frame when the frame is not connected to the power tool, wherein the support is configured to position the frame and the laser generator in an upright manner on a table top such that the laser generator is positioned to direct an illuminated line of light on to the table top.
